(19) United States
(12) Patent Application Publication
(10) Pub. No.: US 2009/0111337 A1
(43) Pub. Date: Apr. 30, 2009

(54) Electrical connector

(75) Inventor: Kenneth M. Kiely, Milford, CT (US)

Correspondence Address: Melvin I. Stoltz, 51 Cherry Street, Milford, CT, 06460, US

(73) Assignee: Bridgeport Fittings, Inc.

(21) Appl. No.: 11/977,906

(22) Filed: Oct. 26, 2007

(51) Int. Cl. H01R 13/02

(52) U.S. Cl. 439/884

(57) ABSTRACT

By providing two integrated components, an outer housing and an inner sleeve member, with the outer housing comprising a generally hollow cylindrical construction incorporating two threaded zones formed at both terminating ends, with the central portion of the hollow cylinder being formed in an arcuate curved shape, an efficient, easily manufactured and assembled cable connector is realized. Using the cable connector of the present invention, the desired metal sheath cable is quickly and easily secured to the connector and mounted in place in virtually any desired angular relationship, with complete assurance that the unwanted movement or withdrawal of the cable from the connector is virtually eliminated.

### TECHNICAL FIELD

This invention relates to electrical connectors, and more particularly, to electrical connectors constructed for securing metal sheath cables to junction boxes and/or outlet boxes.

### BACKGROUND ART

In the field of wiring homes and buildings, whether for new construction or for improvements or expansion, substantial development and product improvements have been made. Typically, these improvements are directed to enabling installers to securely mount any desired wiring in any desired location in the most efficient and quickest manner.

In any particular installation or location, various cables must be interconnected to each other as well as connected to the primary power supply in a suitable power distributing junction box or fuse box. In each of these instances, metal sheath cables, within which the electric power carrying wires are contained, must be securely mounted to the housing of the junction box or outlet box, or connected to appropriate devices, in a protected area.

In order to enable installers to securely mount metal sheath cables to any desired junction box or outlet box, numerous prior art connectors have been developed. However, in spite of the substantial effort that has been expended in developing such connectors, these prior art systems all have drawbacks or difficulties which prevent their universal adoption and use.

In general, the industry has long sought to have a single cable connector which is quickly and easily secured to the end of the metal sheath cable and, once installed, is capable of preventing unwanted movement or dislodgement of the cable from the connector. In addition, the cable connector, with the cable secured therein, must be quickly mountable in secure engagement with any desired junction box or outlet box. Finally, all of these attributes must be achieved in a connector which is inexpensive, in order to enable its acceptance, use, and wide-spread adoption.

One particular area in which a substantial demand exists for a cable connector, without any prior art product being produced for satisfying this need, is in the area of arcuately curved connectors. In many installations, both indoors and outdoors, installers are required to connect metal sheath cables to junction boxes and/or outlet boxes which require a curved or angular connection. Presently, several connectors are required to be mated with each other, in order to achieve the desired curved installation. However, no single, easily installed, affective, construction exists for enabling the direct connection of a metal sheath cable with a junction box and/or outlet box which requires mounted engagement about a curved area.

In particular, this need is most evident in outdoor installations which require moisture proof or rain tight connections. In this regard, in a wide variety of installations, connections must be made to an outlet box and/or junction box wherein the connection must wrap around corners of the buildings, posts, housings, etc. which typically require a 90° or right angle mounted connection. In addition, other angular relationships exist which require mounted engagements at both acute angles and obtuse angles, all of which are not capable of being achieved using existing cable connectors.

Although many prior art connectors have been developed which provide one or more of the attributes detailed above, no prior art connector has been developed which is capable of satisfying all of these long-sought requirements. Consequently, a long-felt need continues to exist for a cable connector meeting these requirements.

Therefore, it is a principal object of the present invention to provide a connector for use with metal sheath cables which provides secure, rapid engagement and retention of the cable in the connector.

Another object of the present invention is to provide a cable connector having the characteristic features described above which is also quickly and easily secured to any desired junction box or outlet box in a manner which assures secure retained engagement therewith.

Another object of the present invention is to provide a cable connector having the characteristic features described above wherein the cable, once mounted to the connector, is incapable of dislodgement or withdrawal.

Another object of the present invention is to provide a cable connector having the characteristic features described above which is constructed with an arcuately curved housing for enabling any metal sheath cable to be interconnected to an outlet box and/or junction box mounted at angular relationships therewith.

Another object of the present invention is to provide a cable connector having a characteristic features described above which is constructed with a housing that incorporates a right angle or 90° curved zone for enabling rapid interconnections around the corners of buildings, posts, housings, and the like.

Another object of the present invention is to provide a cable connector having the characteristic features described above wherein the cable connector is capable of being produced and assembled quickly and easily, thereby providing an inexpensive product.

Another object of the present invention is to provide a cable connector having the characteristic features described above wherein the cable connector automatically provides grounding and/or an electrical flow path through the junction box or outlet box when mounted thereto.

A further object of the present invention is to provide a cable connector having the characteristic features described above wherein the cable connector is self-centering when mounted in a receiving hole and provides a pre-loaded, spring biasing holding force thereto.

Another object of the present invention is to provide a cable connector having the characteristic features described above wherein the cable connector is rain and/or moisture tight to enable its use outdoors or in other high moisture environments without difficulty.

Other and more specific objects will in part be obvious and will in part appear hereinafter.

### SUMMARY OF THE INVENTION

By employing the present invention, all of the difficulties and drawbacks of the prior art systems have been overcome, and an efficient, easily manufactured and assembled cable connector is realized. Furthermore, using the cable connector of the present invention, the desired metal sheath cable is quickly and easily secured to the connector and mounted in place, with complete assurance that the unwanted movement or withdrawal of the cable from the connector is virtually eliminated.

In the preferred embodiment, the cable connector of the present invention comprises two integrated components, an outer housing and an inner sleeve member. As detailed herein, the inner sleeve member is securely mounted to the outer housing in a manner which prevents its separation from the housing. As is more fully detailed below, the inner sleeve member is preferably press fitted into the housing in order to provide the desired secure, integrated affixation of these components. However, if desired, other securement methods well known in the industry may be used.

Preferably, in this embodiment of the present invention, the outer housing comprises a generally hollow cylindrical construction incorporating two threaded zones formed at both terminating ends, with the central portion of the hollow cylinder being formed in an arcuate, curved shape. By employing this construction, the threaded terminating ends of the cable connector are effectively positioned at an angular relationship relative to each other, with an angular relationship preferably ranging between about 10° and 170°. Most typically however the terminating ends of the cable connector of the present invention are formed with an angular relationship ranging between about 750 and 105°.

In addition, the first threaded end of the cable connector of the present invention incorporates a radially extending flange formed on the outer surface thereof directly adjacent the first threaded zone. In addition, the diameter of the first threaded zone is constructed for being associated with a conventional locking ring for being threadedly mounted therewith and inserted into receiving holes formed in conventional outlet boxes and/or junction boxes. In this way, the locking ring is advanced along the first threaded zone into locking abutting relationship with the wall of the outlet box or junction box and the radially extending flange. As a result, the first end of the cable connector of the present invention is quickly and easily inserted into receiving holes formed in conventional outlet boxes or junction boxes and quickly and easily securely mounted therein.

Furthermore, in the preferred embodiment of the present invention, the cable connector also incorporates a sealing bushing or grommet in addition to the inner sleeve member and housing member. By employing the sealing bushing or grommet, a rain tight and/or moisture tight cable connection is attained, enabling the cable connector of this embodiment to be used in a wide variety of applications where high levels of moisture may exist.

In order to assure that the desired rain tight and/or moisture tight cable connection is realized, the cable connector of the present invention is constructed for receiving the sealing bushing/grommet in the second end thereof, with the second end also being constructed for cooperative threaded mounted engagement with a gland nut or hex nut. In this construction, the sealing bushing/grommet is mounted in the cylindrical housing of the cable connector, with the gland nut or hex nut peripherally surrounding and being threadedly engaged with the threaded zone formed on the second end thereof. As a result, the gland nut/hex nut is quickly and easily threadedly mounted to the second end of the cable connector in direct association with the sealing bushing or grommet, providing the desired rain tight or moisture proof sealing construction.

Furthermore, by employing the preferred embodiment of the present invention, the arcuate curved end of each arm member fully engages the outer surface of the cable throughout the entire width of the arm member. In addition, as stated above in the preferred embodiment, the distal end portion of each arm member may be split or bifurcated into two separate finger members, with each finger member preferably comprising two separate and independent angular relationships relative to the major portion of the arm member. By employing this construction, the distal end portions of the arm members are both pitched and sloped, relative to the major portion of the arm member, providing secure, locking engagement with the cable in a plurality of positions.

By designing the slope and/or pitch angles to be substantially equivalent to the slope of the spiral juncture of the metal on the metal sheath cable, each finger of each arm member of the inner sleeve member engages the metal sheath cable directly along the juncture between the metal section, which is defined by the narrow portion or minor diameter of the cable. In this way, secure move-free engagement of the cable is realized and movement of the sheath cable relative to the sleeve member is prevented. Furthermore, by combining the slope and/or pitch angles with an arcuately curved end which matches the curvature of the cable, secure engagement of each finger of each arm member with the cable throughout the entire width of the arm member is achieved.

If desired, the two arm members may be formed at different positions along the axial length of the sleeve member. In this way, the cable engaging end of each arm member interconnects with the metal sheath cable at different longitudinal spaced locations along the length of the cable.

By constructing the inner sleeve member in the preferred manner, each arm member is able to engage the minor diameter of the spiral shaped juncture between the metal portions of the cable. In this way, secure engagement with the optimum area of the cable is provided and completely controlled movement-free securement of the cable by the inner sleeve is achieved.

The invention accordingly comprises an article of manufacture possessing the features, properties, and the relation of elements which will be exemplified in the article herewith described, and the scope of the invention will be indicated in the claims.

### THE DRAWINGS

For a fuller understanding of the nature and objects of the invention, reference should be had to the following detailed description taken in connection with the accompanying drawings, in which:

FIG. 1 is a perspective view of the fully assembled cable connector of the present invention;

FIG. 2 is a front elevation view of the fully assembled cable connector of the present invention;

FIG. 3 is a rear elevation view of the fully assembled cable connector of the present invention;

FIG. 4 is a cross-sectional side elevation view of the cable connector of the present invention shown with the component thereof telescopically displayed; and

FIG. 5 is a cross-sectional side elevation view of the cable connector of the present invention shown fully assembled.

### DETAILED DESCRIPTION

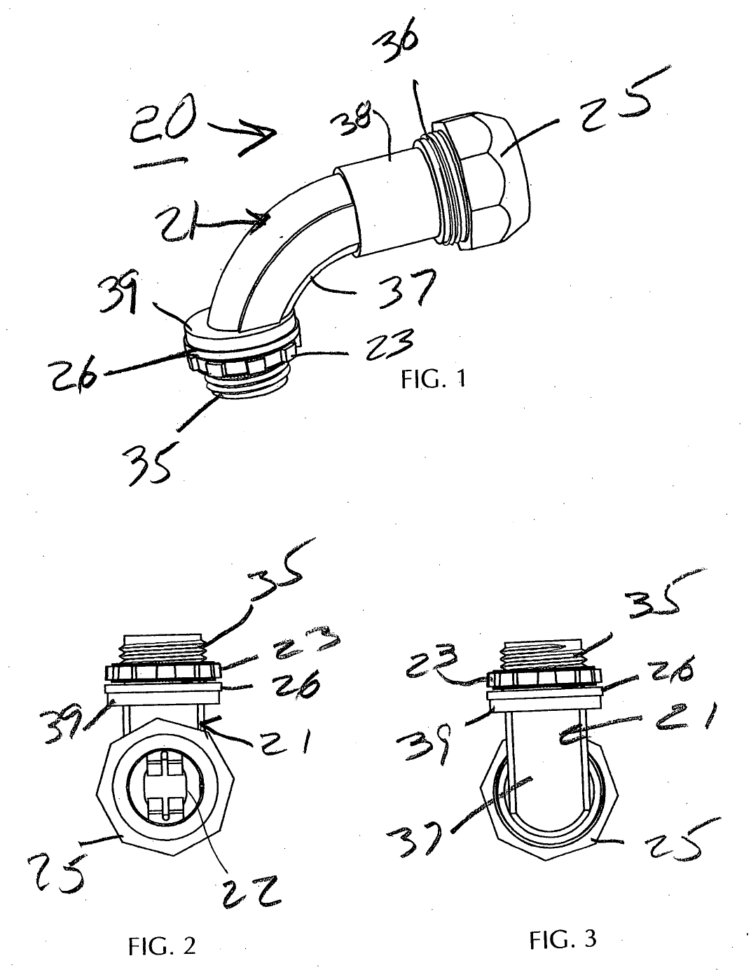

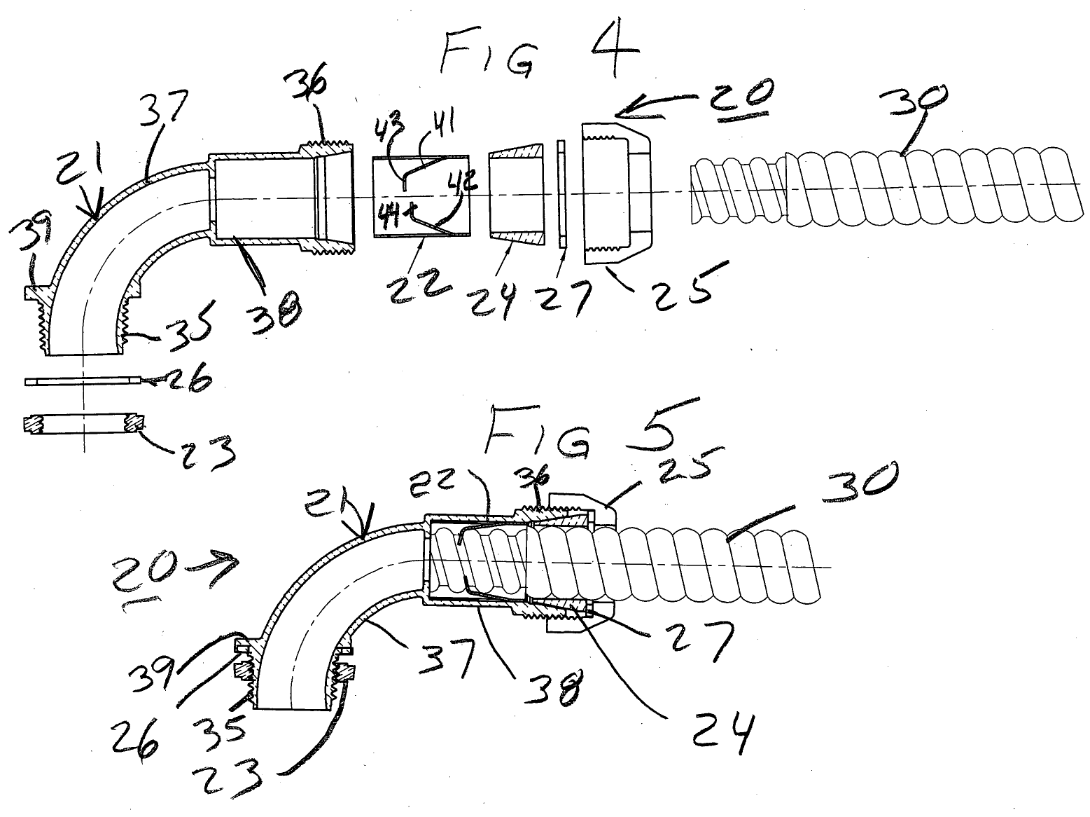

By referring to FIGS. 1-5, along with the following detailed disclosure, the construction and operation of this embodiment of electrical cable connector 20 of the present invention can best be understood. As will be evident to one having ordinary skill in the start, alternate constructions may be implemented using the teaching of the present invention without departing from the scope of this invention. However, it is to be understood that the constructions detailed herein are provided for exemplary purposes only, and are not intended as a limitation of the present invention.

As shown in FIGS. 1-5, the principal components which form cable connector 20 of the present invention comprise housing 21, inner sleeve member 22, locking ring 23, sealing bushing or grommet 24, and gland nut or hex nut 25. In addition, in the preferred embodiment, cable connector 20 also incorporates sealing rings 26 and 27. By forming these component in the manner detailed below, and assembling them as shown in FIGS. 1-5 as detailed herein, the desired unique, construction and configuration of cable connector 20 is realized.

In this embodiment, cable connector 20 is constructed for enabling a shielded, metalclad, or metal sheath electrical cable 30 to be securely mounted to any desired electrical box, junction box, outlet box and/or housing in an easily achieved and quickly installed manner, with said mounted interengagement being achieved for arcuate or angular mounted installations. In addition, in the preferred embodiment, cable connector 20 of the present invention is constructed for enabling the electrical cable 30 to be mounted to the desired electrical box, junction box, outlet box, and/or housing in a moisture tight or rain tight environment. In this way, a wide variety of prior art difficulties and drawbacks are completely eliminated.

As discussed above, many installations require shielded electrical cable 30 to be mounted to a junction box, outlet box, electrical box, and/or housing wherein these components are located outdoors, or in an environment where moisture is known to exist. As a result, the preferred embodiment of connector 20 of the present invention is constructed in a manner which ensures the secure affixation of electrical cable 30 to connector 20 in a completely moisture tight or rain tight manner. However, it desired, connector 20 may be constructed without the use of the moisture proof or rain tight components being employed.

In order to achieve the desired mounted engagement of connector 20 in installations which require an angular connection to be made, connector 20 is constructed with housing 21 incorporating threaded zone 35 formed at one end of housing 21 and threaded zone 36 formed at the opposed end of housing 21.

In addition, housing 21 incorporates a central section 37 which is formed in an arcuately curved shape for enabling connector 20 to be mounted in locations requiring an angular connection. As shown in FIGS. 1-5, connector 20 is constructed with threaded end 35 angularly disposed relative to threaded end 36.

In this most typical construction, threaded end 35 is positioned substantially 90° relative to threaded end 36. However, threaded ends 36 formed in connector 20 can be constructed with any desired angular relationship typically ranging between about 10° and 170°, with 75° to 105° being most typical.

By employing the construction detailed above, connector 20 is able to be installed in locations in which no prior art connector is capable of being used. In this regard, connector 20 provides a single component which enables electrical cable 30 to be quickly and easily directly mounted to any desired junction box, outlet box, electrical box or housing wherein components are positioned at an angular relationship to each other.

In the preferred embodiment, cable connector 20 of the present invention incorporates sealing bushing/grommet 24, and sealing rings 26 and 27 in order to provide the desired rain tight or moisture proof construction. However, if desired, these components can be eliminated if a rain tight or moisture proof configuration is not required.

Furthermore, in order to securely affix metalclad or metal sheath cable 30 to cable connector 20, for enabling the electrical wires contained therein to be secured in the desired position in the outlet box, junction box, electrical box, or housing, cable connector 20 incorporates sleeve member 22 which is constructed for providing the desired mounted, interlocking interengagement of cable 30 with connector 20. In a preferred construction, sleeve member 22 comprises a generally cylindrical shape which is configured for being advanced onto cable 30, peripherally surrounding and lockingly engaging with the metalclad or metal sheath surface thereof.

In this regard, sleeve member 22 comprises a generally hollow cylindrical shape having a diameter greater than the diameter of the outer surface of cable 30 while also incorporating arms 41 and 42 which are constructed for radially extending inwardly. In addition, arms 41 and 42 incorporate engaging tabs 43 and 44 formed at the terminating ends thereof and constructed for secure locking interengagement with the convolutions forming the outer surface of metalclad or metal sheath cable 30.

By employing this construction, or any other equivalent construction, sleeve member 22 is quickly and easily telescopically advanced onto cable 30 and lockingly engaged therewith, with arm members 41 and 42 peripherally surrounding and engaging the outer surface of cable 30. Once in this position, sleeve member 22 is incapable of being removed from cable 30 using normal forces.

In addition, in the preferred construction, sleeve member 22 is constructed for being press fitted into the receiving zone 38 of housing 21. In this way, inner sleeve member 22 is inserted into receiving zone 38 of the housing 21 and advanced therein until frictional engagement is established between inner sleeve member 22 and housing 21. Once in this position, sleeve member 22 and cable 30 are engaged and securely mounted to housing 21.

Once cable 30 and sleeve member 22 are securely mounted to housing 21 of cable connector 20, and threaded zone 35 is secured to the desired cable box, outlet box, electrical box, or housing, the final installation of cable connector 20 is achieved. In this regard, in the preferred embodiment wherein a moisture proof or rain tight connection is desired, cylindrically shaped sealing bushing/grommet 24, gland nut/hex nut 25, and sealing ring 27 are mounted in place. Preferably, sealing bushing/grommet 24, locking ring 26, and gland nut/hex nut 25 are mounted on electrical cable 30 prior to inserting cable 30 into sleeve member 22 and mounting sleeve member 22 in housing 21.

In this way, as shown in FIG. 5, with these components mounted in position, cable 30 and sleeve member 22 are inserted into receiving zone 38 of housing 21 of connector 20, causing sleeve member 22 to be frictionally mounted within receiving zone 38. In addition, sealing bushing/grommet 24 is forced into the opening of receiving zone 38 for being compressed therein. Finally, in order to complete the installation, sealing ring 26 abuts the outer surface of sealing bushing/grommet 24, and gland nut/hex nut 25 is threadedly mounted on threaded zone 36. In this regard, as is evident from the foregoing detailed discussion, the outer diameter of threaded zone 36 and the inner diameter of gland nut/hex nut 25 are constructed for being threadedly interengaged with each other for assuring a secure mounted interconnection therebetween.

With gland nut/hex nut 25 and sealing bushing/grommet 24 securely mounted in place, sealing bushing/grommet 24 is compressed into frictional engagement with cable 30, peripherally surrounding cable 30 and effectively sealing the outer peripheral surface of cable 30 with the entry portal of receiving zone 38. As a result, any moisture or rain which otherwise could enter through the portal of receiving zone 38 is substantially reduced or effectively eliminated. In this way, the desired moisture tight or rain tight securement of cable 30 with connector 20 is realized. If desired, added protection is provided by incorporating sealing ring 27 between gushing/grommet 24 and gland/hex nut 25. In this way, an additional moisture or rain barrier is provided.

In order to assure the sealing engagement of cable 30 with connector 20, sealing bushing/grommet 24 is preferably formed for material suitable for providing deformation, compressibility, and sealing cooperation with cable 30. In this regard, it has been found that nonconductive, elastomeric materials such as rubber-based products or thermoplastic elastomers can be effectively employed to achieve the desired results. As is evident from this disclosure, the actual material employed for sealing bushing/grommet 24 may be selected from a wide variety of alternate compositions, with the only limitation being the use of a material which is capable of compressively surrounding cable 30 and cooperating with cable 30 to effectively seal the entry portal of receiving zone 38.

Once cable 30 has been sealingly mounted to connector 20 in the manner detailed above, the assembly is completed by mounting connector 20 to the desired junction box, outlet box, electrical box, or housing. If desired, connector 20 may be mounted to the desired box or housing prior to the installation of cable 30.

Typically, in order to enable cable connector 20 of the present invention to be quickly and easily inserted into and lockingly engaged with the desired junction box, outlet box, electrical box or housing, threaded zone 35 of connector 20 is constructed with an overall diameter dimensioned for insertion into conventionally sized receiving holes formed in typical junction boxes, outlet boxes, electrical boxes, and housings. In this regard, these receiving holes are generally formed with a protective or knock-out plug or plate mounted therewith which enables the pre-formed holes to be quickly and easily opened for receiving connector 20.

Once threaded zone 35 of connector 20 is inserted through the desired hole of the outlet box, junction box, electrical box, and/or housing, locking ring or nut 23 is advanced along the threads of threaded zone 35 until locking ring/nut 23 is brought into abutting contact with the wall of the box or housing. Once secured in place, connector 20 is affixed to the desired box or housing, and the electrical wires contained in metalclad or metal sheath cable 30 can be secured in the desired positions.

In the preferred construction, housing 21 of connector 20 incorporates radially extending flange 39 which peripherally surrounds threaded zone 35 and extends outwardly therefrom. In order to assure the desired cooperative interengagement, radially extending flange 39 comprises a diameter greater than the diameter of the aperture of the junction box, outlet box, electrical box, or housing into which connector 20 is secure. In this way, flange 39 prevents connector 20 from advancing into the aperture beyond the desired point by abutting the side wall of the junction box, outlet box, or housing, thereby assuring cable connector 20 is mounted in a precisely desired position.

In order to securely affix connector 22 in the desired junction box, outlet box, electrical box, or housing, locking ring or nut 23 is employed. With connector 20 mounted in the desired position, as detailed above, locking ring/nut 23 is threadedly advanced onto threaded zone 35 of housing 21 by engaging the threads of the locking ring/nut therewith. Then, ring/nut 23 is advanced into secure engagement with the inside wall of the junction box, outlet box, electrical box, or housing, securely mounting connector 20 in the desired position. In addition, by employing the construction detailed above, connector is secured in a manner which provides rain tight or moisture proof mounting of cable 30.

In order to further enhance the rain tight or moisture proof construction, sealing ring 26 may be mounted between locking ring/nut 23 and the wall of the housing. In this way, added moisture protection is provided.

As is evident from the foregoing detailed disclosure, the present invention is capable of being manufactured in numerous alternate embodiments, with each alternate embodiment incorporating a wide variety of alternate constructions. However, as is clearly evident to one having ordinary skill in the art, the various constructions can be freely employed with any embodiment, thereby further increasing the possible alternate constructions for the present invention which come within the scope of this discovery. Consequently, it is to be understood that the various embodiments detailed herein along with the construction details thereof, are provided for exemplary purposes and the alternate combinations of features, elements, and arrangement of parts and components can be achieved without departing from the scope of this invention.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described my invention, what I claim as new and desire to secure by Letters Patent is:

1. An electrical connector for securely engaging and mounting an electrical cable to a receiving a box or plate having a receiving hole formed therein, said electrical connector comprising a housing comprising:
A. an elongated, hollow shape defined by an outer wall, an inner wall, a first terminating end defining a first portal having a first central axis and a second terminating end defining a second portal having a second central axis;
B. a central section formed between the first terminating end and the second terminating end and
a) comprising an elongated longitudinally extending portion effectively positioned and interconnecting the first terminating end with the second terminating end;
b) comprising an elongated, longitudinally extending axis having an accurately curved shape, interconnected at one end thereof with the first central axis of the first terminating end and interconnected at the opposed end thereof with the second central axis of the second terminating end, and
c) effectively positioning the first terminating end and the second terminating end in relative positions wherein the first central axis of the first terminating end is maintained in a non-coaxially aligned position with the second central axis of the second terminating end;
C. a first threaded zone formed on the outer surface of the housing adjacent the first terminating end and a second threaded zone formed on the outer surface of the housing adjacent the second terminating end;
D. a flange mounted to the outer wall of the housing adjacent the first threaded zone and radially extending outwardly therefrom and comprising a diameter greater than the diameter of the receiving hole formed in the receiving box/plate;
E. a locking ring/nut constructed for threaded mounted engagement to the first threaded zone of the housing for securely affixing the housing in a receiving hole of a receiving box/plate; and
F. an inner sleeve member comprising
a) a substantially hollow, substantially cylindrical shape, constructed for peripherally surrounding and securely engaging the outer surface of an electrical cable, and
b) dimensioned for being inserted into the second end of the housing for being securely retained therein, in frictional engagement with the inner surface thereof;
whereby an electrical connector is achieved which is quickly and easily assembled and securely mounted to any desired box or plate, for enabling the secure, direct, mounted engagement of an electrical cable with said box or plate at angular relationships therewith.

2. The electrical connector defined in claim 1, wherein the central section comprises an accurately curved shape wherein said arc ranges between about 10° and 170°.

3. The electrical connector defined in claim 2, wherein said actuate curve is further defined as a ranging between about 75° and 105°.

4. The electrical connector defined in claim 2, wherein said connector further comprises a gland nut or hex nut constructed for cooperative association with the housing for being threadedly interengaged with the second threaded zone thereof for securely maintaining the inner sleeve member in the desired position.

5. The electrical connector defined in claim 4, and further comprising a sealing bushing or grommet comprising a generally hollow cylindrical shape, constructed for being inserted into the second end of the housing in contacting, sealing engagement with a portion of the inner wall of the housing, peripherally surrounding and sealingly engaging the electrical cable mounted therein.

6. The electrical connector defined in claim 5, wherein said gland nut/hex nut is constructed for applying a compressive force to the sealing bushing/grommet for assuring sealed contact with the outer surface of the cable, thereby providing a construction which is substantially moisture free and/or rain tight.

7. The electrical connector defined in claim 6, and further comprising a sealing ring constructed for being mounted between the sealing bushing/grommet and the gland nut/hex nut, for further enhancing the moisture proof or rain tight interengagement thereof.

8. The electrical connector defined in claim 2, wherein said inner sleeve member is further defined as comprising two arm members extending inwardly from the inner surface of the sleeve member with said arm members being positioned for mating engagement and securement with the electrical cable when said cable is inserted through the sleeve member.

9. The electrical connector defined in claim 8, wherein said arm members are further defined as being positioned in juxtaposed relationship to each other, and formed on opposed sides of the sleeve member in spaced, cooperating, facing relationship with each other.

10. The electrical connector defined in claim 9, wherein said electrical cable is further defined as comprising a curved outer surface and said arm members of the sleeve member are further defined as comprising curved terminating edges constructed for mating engaged relationship with the surface of the electrical cable for providing secure interengagement therewith.
